(19) United States
(12) Patent Application Publication
(10) Pub. No.: US 2015/0108165 A1
(43) Pub. Date: Apr. 23, 2015

(54) PACKAGE FOR LIQUID PRODUCTS

(71) Applicants: Oscar Merner, Stockholm (SE); Henrik Seidlitz, Stockholm (SE)

(72) Inventors: Oscar Merner, Stockholm (SE); Henrik Seidlitz, Stockholm (SE)

(21) Appl. No.: 14/588,541

(22) Filed: Jan. 2, 2015

Related U.S. Application Data
(63) Continuation-in-part of application No. 13/580,004, filed on Aug. 20, 2012, now abandoned.

(30) Foreign Application Priority Data
Feb. 19, 2010 (SE) 1000167.5

(51) Int. Cl. B67D 3/00; B65D 77/06

(52) U.S. Cl. CPC B67D 3/0067; B65D 77/067
USPC 222/105

(57) ABSTRACT

A package for liquid products containing an air-tight bag adapted for containing and discharging a liquid product, wherein the bag includes an outlet part adapted to discharge the liquid product when a tap is open, and an outlet part arranged in the package such that the entire outlet part or part thereof during use can be grasped and moved by a user to a stop position, and wherein the outlet part is surrounded by a guiding part that has one end thereof attached to the bag.

### RELATED APPLICATION

This application is a continuation-in-part of U.S. patent application Ser. No. 13/580,004, which is a national phase of International Application No. PCT/SE11/050181 filed Feb. 18, 2011, which claims priority of Swedish Patent Application No. 1000167.5 filed Feb. 19, 2010, all of which are hereby incorporated herein by reference.

### TECHNICAL FIELD

The present invention relates to a package for liquid products. In particular, the present invention relates to such a package having an air-tight bag.

### BACKGROUND

Packages for liquid products comprising an air-tight bag are well known. Such packages have been used for fruit juices since the fifties and for vine since the end of the sixties when the first so-called “box vine” also called “bag-in-box vine” was launched. Once a vine bottle has been opened, the content is exposed to air and the content starts to oxidize, as is well-known, rendering the vine being unpleasant to drink in a few days. “Bag-in-box” is a cardboard box having an air-tight bag provided with a tap mounted therein, which sinks in when the vine (or any other drink) is discharged when the tap is opened. In this way, the air is prevented from reaching the vine, and at the same a user can easily tap the amount desired, for instance a glass of vine.

At the same time, as an ever increasing amount of the vine of the world was bottled in bag-in-box, an ever increasing amount of liquid products was bottled in the air-tight bags. Groceries such as ketchup, sauces, syrups, juices and oils, and milk have since long ago been delivered in such packages. The last years, the market for medical products in bag-in-box has grown, much due to the ability of the technique to secure 100 percent sterility. Food to restaurants is often delivered in bag-in-box of the same reason.

Bag-in-box packages are described in several documents such as for instance EP-A1-0350243 and EP-A1-1842791.

A disadvantage with prior art bag-in-box packages is that it is often difficult for a user to pull out the tap of the package. Normally, a number of measures and hand grips are required before the tap is in operating position. This problem also exists for other types of similar packages.

### DESCRIPTION OF THE INVENTION

According to an aspect of the present invention, this is provided by a package containing a bag provided with an outlet part having a tap that can be pulled out in a single hand grip, wherein the outlet part is surrounded by a funnel-shaped part.

An object of the present invention according to a first aspect is to improve opening of the package for persons that can have difficulties with that; the package is typically more ergonomic. In a simple hand grip, the outlet part provided with the tap can be pulled out.

The outlet part provided with a tap according to the present invention, different to what is known in for instance EP-A1-0350243 and EP-A1-1842791, is located inside the package before the opening and use. This provides that the tap also can be kept clean and helps during transportation because it cannot be damaged or worn against other packages. The taps of known packages are exposed to an outer side, both during transportation and use.

According to an embodiment of the present invention, there is provided a package for liquid products. The package contains an air-tight bag adapted to contain and discharge a liquid product. The bag further contains an outlet part provided with a tap, when opened, arranged to discharge the liquid product. The outlet part is arranged to the bag and in the package such that the entire outlet part or part thereof during operation can be pulled out, or screwed out of the package in a side thereof by means of a user providing a single hand grip to pull out, screw out or turn out the outlet part or part thereof of the side of the package to a stop position. Surrounding the outlet part, there is provided a guiding part, for instance a swing-hatch part provided as a swing hatch in a frame part attached to the package, arranged surrounding the outlet part and at an end thereof being attached to the bag.

Typically, the outlet part is arranged to be telescopic, or turned at a part of the wall of the package.

According to an embodiment of the present invention, the outlet part comprises an inner tube being arranged to be turned inside an outer tube by means of threads. Alternatively, the inner tube is arranged to slide inside the outer tube in guides.

Alternatively, the outlet part comprises a tube of bellows type.

According to an embodiment of the present invention, the bag is integrated with the package and the outlet part is arranged to seal the package and during use thereof arranged to be screwed a distance such as half a turn to expose an opening from which the liquid product can be discharged.

Different embodiments of the present invention will now be illustrated by means of different drawing figures, which will be described in more detail as follows below.

### DRAWING FIGURES

FIGS. 1A and B show a package for liquid products according to an embodiment of the present invention having an outlet part with threads, wherein the outlet part is surrounded by a funnel shaped part;

FIGS. 2A and B show a package for liquid products according to an embodiment of the present invention having a telescopic outlet part provided with guides, wherein the outlet part is surrounded by a funnel-shaped part;

FIGS. 3A and B show a package for liquid products according to an embodiment of the present invention provided with an outlet part comprising a telescopic tube, wherein the outlet part is surrounded by a guiding part provided as a funnel-shaped part;

FIGS. 4A and B show a package for liquid products according to yet another embodiment of the present invention provided with an outlet part comprising an outlet part of bellows-shaped tube type, wherein the outlet part is surrounded by a funnel-shaped part; and

FIGS. 5A-B show a package for liquid products according to yet another embodiment of the present invention provided with an outlet part, wherein outlet part is surrounded by guiding part provided as a swing-hatch in a frame.

### DESCRIPTION OF EMBODIMENTS ACCORDING TO THE PRESENT INVENTION

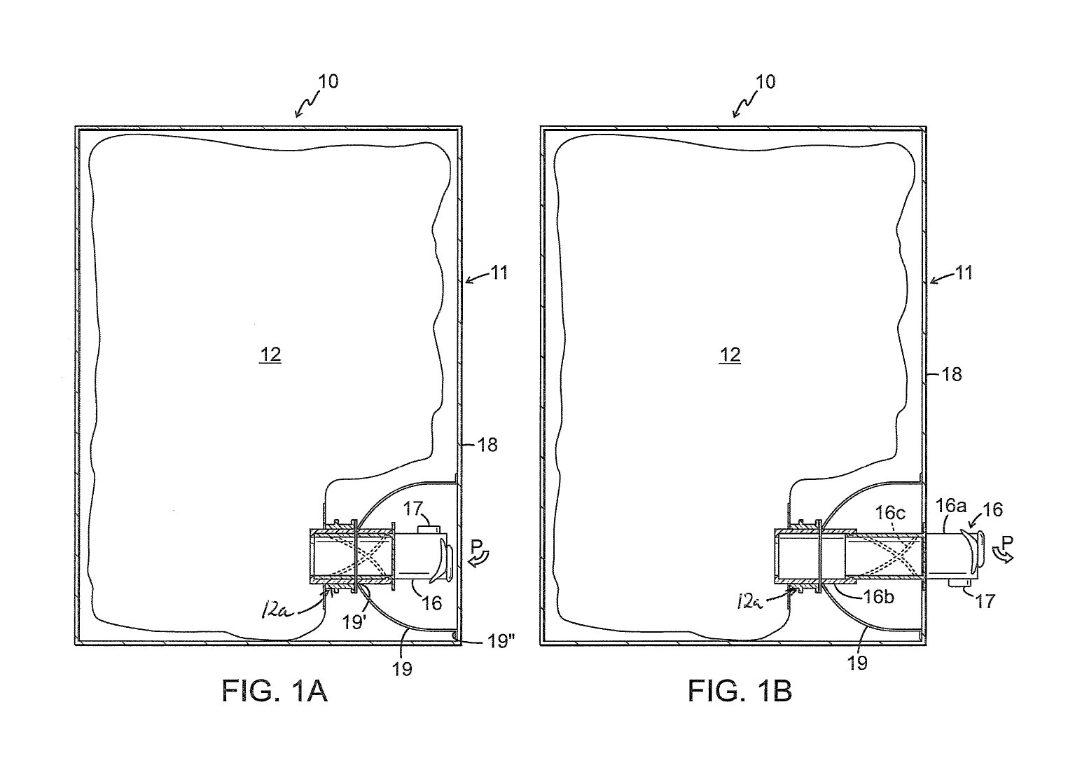

Now is referred to FIG. 1A showing a package for liquid products according to an embodiment of the present invention.

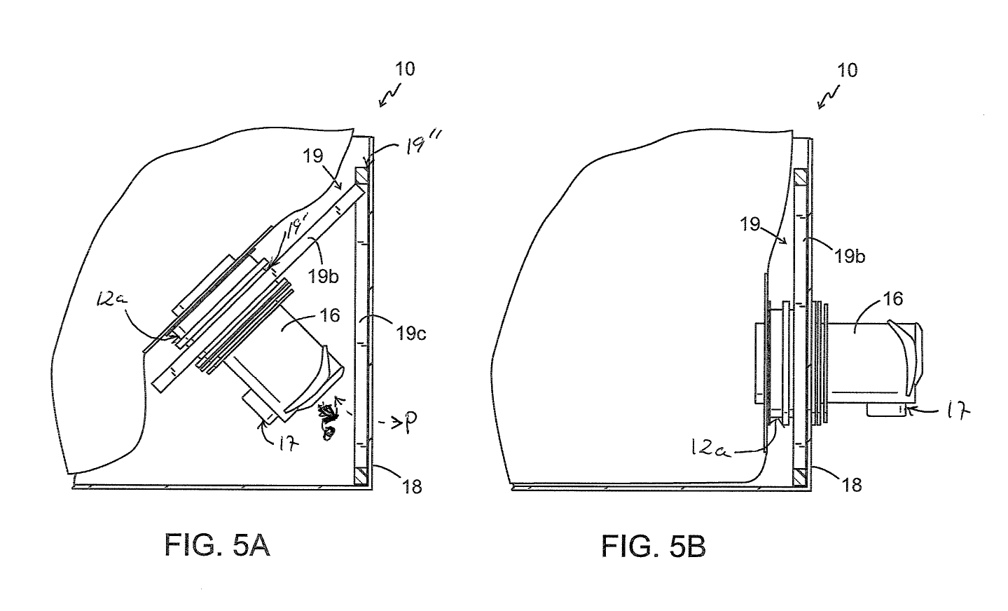

FIGS. 1A and 1B show a package 10 for liquid products. The package is particularly suitable for vines, but it can also be used for all kinds of liquid products such as ketchup, sauce, syrup, juice and cooking oil, as well as different kinds of medical products. The package 10 comprises a cardboard box 11, which contains a bag 12 being air-tight adapted to contain and discharge a liquid product (not shown). The bag 12 furthermore comprises an outlet part 16, which comprises an inner tube 16a, which is rotatable mounted inside an external tube 16b with threads 16c, typically coarse threads (only shown schematically). The outlet part 16 is arranged to during opening of a tap 17 (only shown schematically) arranged therein discharge the liquid product. In FIG. 1A, the tap 17 is shown as normally arranged in the package 10 before use, i.e. it is turned upwards in the drawing. The arrow P is intended to show how a user (not shown) by tearing away part of the wall or in some other way opening the package 10 exposes the outlet part 16 such that it can be turned or screwed out. The outlet part 16 is arranged to the bag 12 and in the package 10 such that the outlet part 16 or part thereof during use can be screwed out of the container (box) of a side thereof by means of a user turning, typically screwing the outlet part 16 out or even more typically only part thereof, such as for instance 4 cm, out of the side of the package 18 to a stop point. Typically, the outlet part is screwed half a turn. Suitably, this is achieved by means of part of the side of the package being torn loose such the outlet part 16 is exposed and then screwed out. This is shown in FIG. 1B, showing the outlet part in position screwed out with the tap 17 pointing downwards such that the liquid product can be tapped by flowing down through the outlet orifice of the tap 17 (when a user in a conventional way opens the tap 17). The tap 17 per se and it's opening-/closing operation will not be described in more detail since it is well known and does not form part of the invention. The attachment of the outlet part 16 to the bag 12 will not be described in more detail since it is of conventional type. For instance, the bag can be welded to or molded in one piece with a conventional tap. Surrounding the outlet part 18 (in inner position) is a guiding part 19; herein a funnel-shaped part 19 provided surrounding the outlet part 16 and also holding it in place when a user screws out the outlet part 16. The funnel-shaped part 19 is at one of it's ends 19′ attached to the bag and at the other end 19″ to, or not to, the side, typically an inside of the package 18. The funnel-shaped part 19 can be circular in a cross-section but can also be a polygon provided it is adapted according to the drawing figure and is capable to hold the outlet part in position when a user pulls out or screws out part of the outlet part 16, i.e. such that not the entire outlet part 16 is pulled out but only part thereof. The term “funnel-shaped” is in this context referred to all kinds of doomed sides, i.e. the funnel-shaped part's sides 19 do not have to be straight. In FIG. 1A and B it is evident how a doomed funnel can be embodied. Other types of means holding part of the outlet part 16 are also possible such as shown in FIGS. 5A-5B.

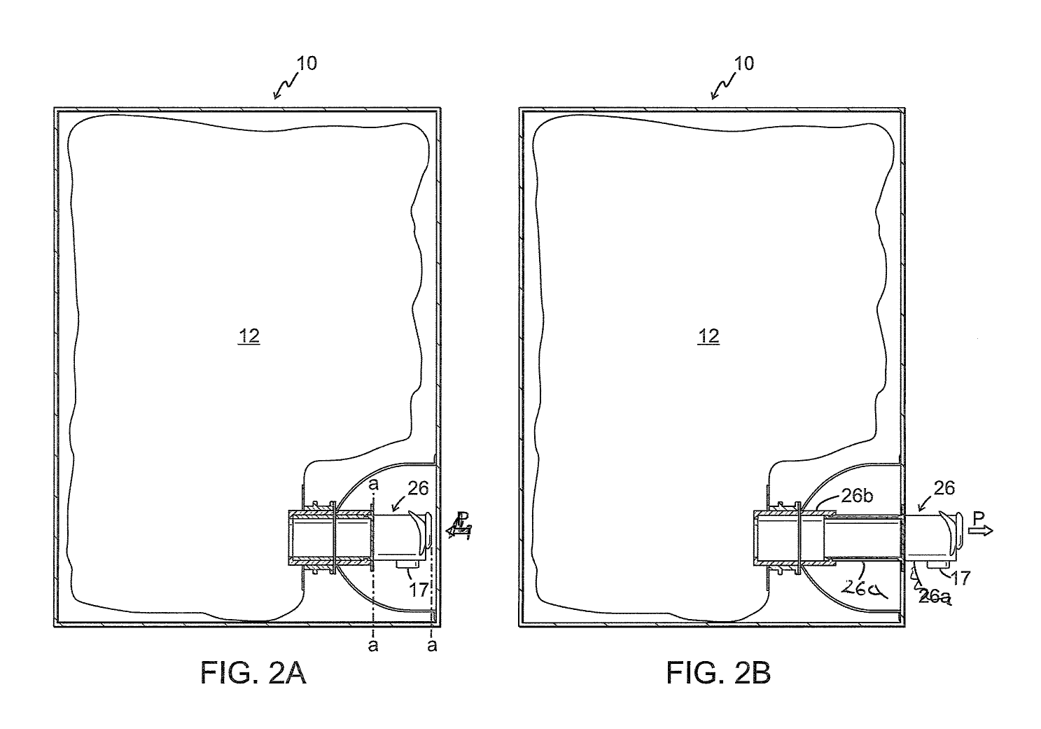

According to an embodiment of the present invention, the outlet part 16 can comprise a telescopic outlet part 26 instead of the outlet tube 16a that can be turned in as shown in FIGS. 1A-1B having threads, comprising an inner tube 26a being arranged to slide inside an outer tube 26b adapted to the inner tube 26a. This is shown in FIGS. 2A-2B. FIG. 2A shows the outlet part in non-extended inner position a-a intended to show the position the outlet part 16 has before the package has been opened by a user. In FIG. 2B there is shown the outlet part 26 in extended outer position (see arrow P) such as it looks like when a user has pulled out the inner tube 26a to it's outermost position and the tap 17 is in use position (discharging position). In this embodiment the tap is directed downwards. In FIG. 2B, there is shown a telescopic tube 26 having two tubing parts 26a, and 26b. This is only an example and the number of tubing parts can vary depending on use. For instance, it can be suitable to use two tubing parts.

Preferably, the telescopic tube 26 is arranged to be extendable in guides (not shown). These guides are not shown explicitly in detail since these are well-known per se as regards the function for a person skilled in the art. The telescopic tube 26 can alternatively according to an embodiment, which is not shown, both be screwed and pulled out simultaneously.

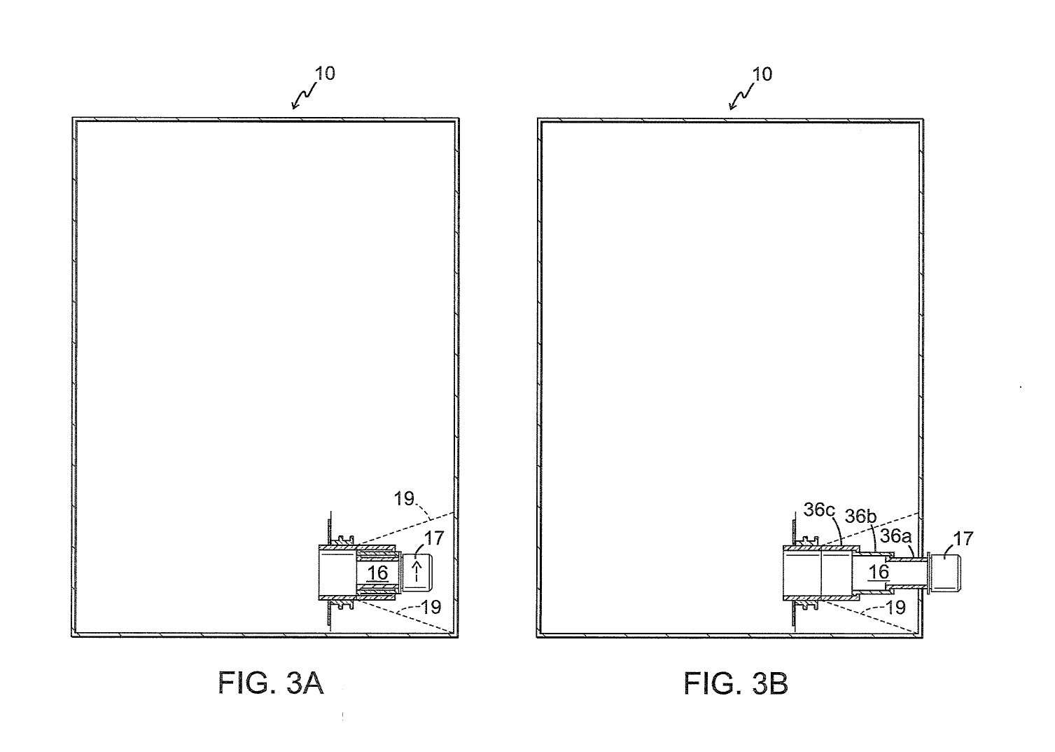

According to yet another embodiment of the present invention shown in FIGS. 3A and 3B, the outlet part 16 comprises a telescopic tubing comprising more than one tube, in this particular embodiment three, 36a, 36b and 36c, which are arranged concentrically into each other and where the two smaller tubes 36a and 36b can be slid inside a larger tube 36c. The tap 17 is of an alternative embodiment (conventional screw tap) than the one in FIGS. 2A and 2B. The function in general corresponds to the embodiment shown and described in relation to FIGS. 2A and 2B. Note that the funnel-shaped part 19 of this embodiment has straight sides. In other embodiments the sides can have other shapes.

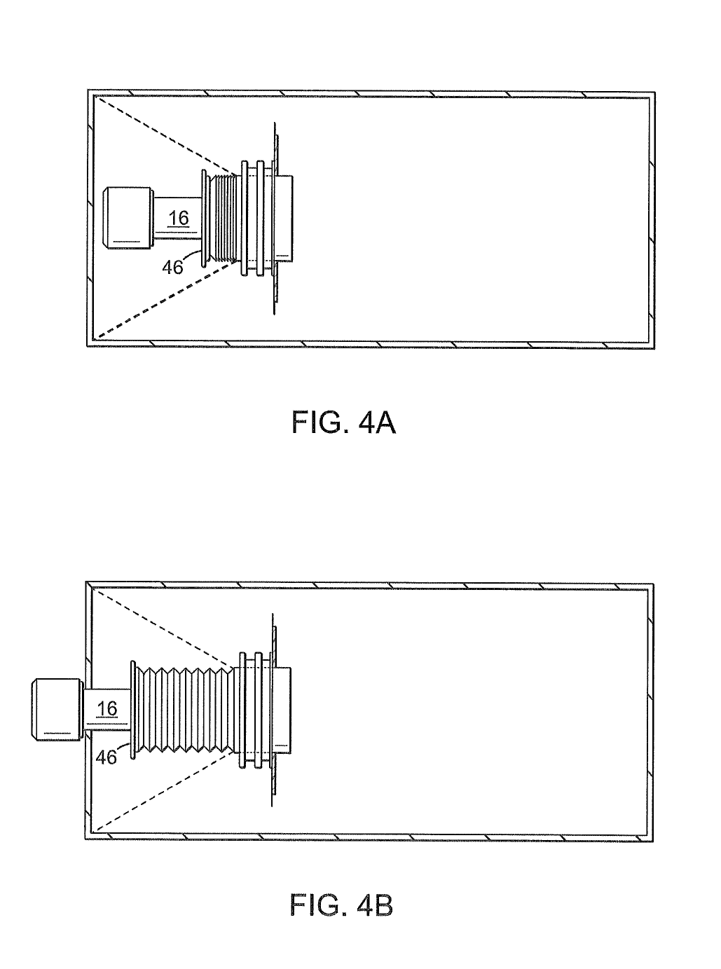

According to an alternative embodiment of the present invention, the outlet part 16 can comprise a bellows-shaped tube 46. In FIG. 4A, the outlet part 16 is in inner position and intends to illustrate the position the outlet part 46 has before the package has been opened by a user.

The outlet part 16 and the tap 17 can be made of suitable material, but normally they are made of polymer material such as plastics.

The design with a tight, soft plastic bag inside a stiff cardboard box a so-called “bag-in-box” is not unique for the invention but the guiding part 19. Bag-in-box vines normally come with a tap providing it easy to tap vine in glasses, because of that the invention is particularly suitable for, but not limited to such use. The package aids transportation because it weighs less, does not crack and is easier to stack, since it is block-shaped. Often, there is also a handle. Since the package easier can be re-sealed and does not let any oxygen in, the durability can often be longer compared to a conventional opened bottle of vine.

FIGS. 5A-5B show an alternative embodiment of the present invention having a guiding part 19 embodied as a swing-hatch within a frame part. Herein this embodiment of the present invention, the outlet part 16 is arranged with respect to the bag 12 in the package 10 such that the entire outlet part 16 or a part of the outlet part 16 during use can be pulled out from a storage position within the package through an opening (not shown) in the side wall 18 to a dispensing position (See FIG. 5B) by a user (See arrow P in FIG. 5A) on the outlet part 16. Typically the guiding part closes the opening in the side wall 18 when the outlet part 16 is in the dispensing position (See FIG. 5B). The outlet part 16 is guided by the guiding part 19 that has one end 19′attached to the bag 12, typically held to the bag 12 by the outlet part 16 and another end of the swing-hatch 19b being pivotally attached to the frame part 19c. The bag 12 has a tubular part 12a fixed thereto and the guiding part 19, herein the frame part 19c, is clamped against the tubular part 12a when the outlet part 16 is fixed to the tubular part 12a. The outlet part 16 can be screwed onto the tubular part 12a thereby attaching the frame part 19c to the bag 12.

When a user opens the package 10 and pulls the outlet part 16 being attached into the swing-hatch 19b, the swing-hatch 19b swings towards a plane of the frame part 19c and is exposed outside the side wall 18 to a user (See FIG. 5B). The swing-hatch 19b is typically attached to the frame part 19c to an upper portion of the frame part 19c. The guiding part 19 is at one of it's ends 19′ attached to the bag 12 and may or may not be attached to the package 10 at it's other end 19″. The swing-hatch 19b and frame part 19c are not visible from the outside of the package 10 when the package is closed (unopened). Once the package 10 is opened, the tap 17 attached to the guiding part 19 can easily be pulled out in place by one single grip and movement, and after use pushed back in (see FIGS. 5A and 5B double headed arrow P). This is in contrast to prior art, which typically has a visible part on the outside before the package is opened. The guiding part 19 surrounds the outlet part 16 and separates the outlet part 16 from the bag 12. The bag 12 is therefore protected as well as more visually aesthetic.

The guiding part 19 is a separate part, which can be inserted into any existing Bag-in-box package. The guiding part 19 is typically not attached to the package 10 and not a part of the package 10, but a separate part. Typically, the frame part 19c encircles the opening in the side wall 18. The guiding part 19 is only attached to the bag 12 at one end 19′, for instance by the outlet part 16 being screwed onto the tubular part 12a fixed to the bag 12 attaching, typically clamping, the guiding part 19 to the bag 12 and typically not attached to, but may be attached to, for instance by bonding to, the package 10 itself at another end 19″ of the guiding part 19. The tubular part 12a may be formed integrally with the bag 12 or fixed by suitable means to the bag 12, such as by bonding, or more particularly by an adhesive or welding.

The guiding part 19 can be used in any Bag-in-box package and using any outlet part 16. The guiding part 19 is mounted between the bag 12 and the outlet part 16 as a separate part.

The outlet part 16 comprises a standardised tap 17 mounted to a conventional, typically plastic, bag, used in a standard bag-in-box solution. The bag 12 does not have to be pierced.

What is claimed is:

1. A package for liquid products, said package comprising a bag or containing and discharging a liquid product, wherein the bag includes an outlet part for discharging the liquid product when opening a tap in the outlet part, said outlet part being arranged with respect to the bag and in the package such that the entire outlet part or a part of the outlet part during use can be pulled out from a storage position within the package through an opening in a side wall of the package to a dispensing position by a user with a single grip on the outlet part, and wherein the outlet part is guided by a guiding part that has one end attached to the bag and another end may be attached to the package, and wherein the guiding part is provided as a swing-hatch in a frame part.

2. The package of claim 1, wherein the frame part encircles the opening in the side wall and is attached only to the inside of the box whereby no part of the frame is visible when the box is closed.

3. The package of claim 2, wherein the guiding part closes the opening in the side wall of the package when the outlet part is in the dispensing position.

4. The package of claim 1, wherein the guiding part closes the opening in the side wall of the package when the outlet part is in the dispensing position.

5. The package of claim 1, wherein an end of the swing-hatch is pivotally attached to the frame part.

6. The package of claim 1, wherein an end of the swing hatch is attached to an upper portion of the frame part.

7. The package of claim 1, wherein the guiding part is held to the bag by the outlet port.

8. The package of claim 7, wherein the bag has a tubular part fixed thereto, and the guiding part is clamped against the tubular part when the outlet part is fixed to the tubular part.

9. The package of claim 8, wherein the outlet port is screwed onto the tubular part.
